(19) United States
(12) Patent Application Publication
(10) Pub. No.: US 2025/0204677 A1
(43) Pub. Date: Jun. 26, 2025

(54) RECEPTACLE DEVICE FOR A TOOL AND DEVICE COMPRISING A RECEPTACLE DEVICE AND A TOOL

(71) Applicant: MARTOR KG, Solingen (DE)

(72) Inventors: Martin ROHRBACH, Göggingen (DE); Kerry HENN, Solingen (DE)

(21) Appl. No.: 18/918,688

(22) Filed: Oct. 17, 2024

(30) Foreign Application Priority Data
Oct. 23, 2023 (DE) 10 2023 129 074.6
Apr. 24, 2024 (DE) 10 2024 111 545.9

(51) Int. Cl. A45F 5/00; A45F 5/02

(52) U.S. Cl. CPC A45F 5/1575; A45F 5/021

(57) ABSTRACT

A carrying device for a tool, including a receiving device with a receiving space for receiving the tool, and a holding device for mounting and fastening the receiving device to a base part. The receiving device is assigned a blocking device that can be moved between a blocking position and a release position by an actuation, with which the tool can be releasably locked in the carrying device.

The invention relates to a carrying device for a tool, in particular for a knife.

Such a carrying device is known from obvious prior use. The carrying device comprises a receiving device with a receiving space for receiving a knife. The knife can be inserted into the receiving space via an opening. The receiving device comprises a holding device for holding the receiving device on an item of clothing, such as a belt. The knife can be inserted into and removed from the receiving space. It is only received loosely in the carrying device.

When carrying out manual work, it is not uncommon for work positions to be adopted wherein the opening for inserting the tool into the receiving space of the receiving device is not pointing upwards, i.e. the receiving device is not aligned vertically. In this case or in the event of a sudden movement by the user, the tool may fall out of the receiving device. The carrying device can, for example, also be adjustable relative to a fastening device, in particular rotatable, in order to adapt the receiving device to certain postures and working positions. In this case, there is also a risk of the tool falling out. When working on scaffolding, for example, the tool may then fall down and injure other people or be lost. The tool may also injure the user if it falls out.

The object of the invention was to create a carrying device in which the tool is held securely in the carrying device and injury to the user and third parties is safely prevented.

The object has been achieved by a carrying device having the features of claim 1.

The carrying device for a tool comprises a receiving device with a receiving space and an insertion opening for at least partially receiving the tool in the receiving space. When the tool is in its seat in the receiving space, a part of the tool protrudes from the receiving space, for example. The tool can then be easily gripped by the user to remove it from the receiving space. A holding device is designed to connect the receiving device to a fastening device. By means of the fastening device, it is possible to store and fasten the receiving device, for example, on an item of clothing, such as a belt, or on a holder of a piece of furniture, such as a machine.

The receiving device is assigned a blocking device that can be moved between a blocking position and a release position by means of an actuation. The blocking device can be used to detachably lock the tool in the carrying device. In the blocking position, a latch engages in a movement path for removing the knife from the receiving space in such a way that the knife cannot be removed from the receiving space.

With the carrying device according to the invention, unintentional movement of the tool out of the receiving device can be reliably prevented when the blocking device is in the blocking position. In the release position, the tool can be easily removed from the receiving space of the receiving device because no clamping or locking of the tool in the receiving device is required. It is therefore impossible to injure the user or third parties or to lose the tool.

The actuation comprises, for example, a button that has at least one actuation region to move the blocking device between the blocking position and the release position. The button is arranged, for example, on the receiving device. The tool only has one actuation region, for example. The blocking position and the release position are then controlled via this one actuation region. For example, actuating the actuating region once moves the blocking device from the release position to the blocking position and actuating the actuating region again moves the blocking device from the blocking position to the release position.

For example, the button comprises two actuation regions, wherein a first actuation region is designed to actuate the blocking position and a second actuation region is designed to actuate the release position. If there are separate actuation regions for actuating the blocking position and the release position, there is no doubt for the user as to which state the blocking device is set to by actuation of the respective region.

The button can be moved, for example, by translational displacement and/or by rotation between the blocking position and the release position. A mixed movement of translational displacement and rotation is also possible in order to adjust the button. In the case of translational displacement, the button is moved parallel to a wall surface of the receiving device, for example, or alternatively perpendicular to the wall surface. In the case of rotational displacement, the button is moved about a pivot journal, which is mounted on or formed by the receptacle, for example.

The button can be moved, for example, into a first stable position and into a second stable position, wherein the first position is assigned the blocking position and the second position is assigned the release position. Stable position in the sense of the invention means that the button remains in the position in which it was set. For example, a resistance to be overcome can prevent the button from moving unintentionally from the set position to another position. For example, the receptacle has a structure which is arranged in the path of movement of a counter-structure of the button when the button is moved between the first position and the second position. The structure and/or the counter-structure are flexibly deformable so that the counter-structure can pass through the structure by overcoming the deformation force.

The stable states of the button in the blocking position and in the release position contribute to increased safety, because the user can easily place the tool in the receiving space of the receiving device or remove it therefrom in the release position. The button does not need to be pressed during insertion or removal from the receiving space. In the blocking position, it is ensured that the blocking device does not move out of the blocking position.

The button can be latched in the blocking position and/or in the release position, for example. The button then does not move out of the set position unintentionally. Latching is performed by a latching device, which comprises, for example, first latching means assigned to the button and second latching means assigned to the receiving device.

The button is designed as a two-armed lever, for example, wherein two actuation regions are separated from each other by a pivot axis. The button can be pivoted about the pivot axis between the blocking position and the release position. Depending on which actuation region is actuated, the button pivots and moves into the blocking position or the release position.

A first actuation region of the button is, for example, larger in relation to a second actuation region. This makes it easier for the user to recognize the actuation regions and assign them to the respective function. If, for example, the larger actuation region is assigned to the blocking position, the user can also secure the lock more easily in the receiving space due to the larger actuation region, because this region is easier to operate.

For example, the button is located on the outside of the receiving device. Both when the carrying device is worn by a person and when the carrying device is attached to a piece of furniture, these features enable easy and ergonomic actuation because the button is easily accessible.

The button is arranged, for example, on an outer side facing away from the holding device. The sides facing away from the holding device are the sides of the outer surface of the holding device that do not have the holding device.

For example, the button is directly or indirectly connected to first blocking means, e.g. a blocking pin, which can be moved into a movement path of the tool in order to prevent the tool from moving out of the receiving space in the disassembly direction. The first blocking means co-operate with second blocking means of the tool to lock the tool in the receiving space. If the button is indirectly connected to the first blocking means, a mechanism moves the first blocking means between the blocking position and the release position, for example, depending on the position of the button. If the button is directly connected to the first blocking means, these can, for example, be attached to the button or be formed in one piece with it. In this case, the first blocking means are moved directly by the movement of the button. The first blocking means engage in the receiving space in such a way that the tool collides with them when moving in the disassembly direction out of the receiving space of the receiving device, so that further movement is prevented.

At least one region of the first blocking means can be moved into the receiving space, for example through an opening in the wall of the receiving device. The first blocking means can, for example, be arranged at least partially outside the receiving space in the release position and at least partially inside the receiving space in the blocking position. To enable this movement from one position to the other, the wall of the receiving device has, for example, the opening through which the first blocking means pass and in which they are movable.

For example, the receiving device has haptic detection means for localizing the arrangement of the button on the receiving device and/or the respective region for actuating the blocking position and the release position by touch. It is then possible to feel the button on the receiving device without having to look at the receiving device. Such haptic recognition means can be, for example, a raised rim around the button or a structure on the button that can be recognized by touch or on the respective region of the button, e.g., region for blocking or region for releasing.

The tool is designed as a knife, for example, or comprises a knife.

According to a second aspect, the invention also relates to a device comprising a carrying device and a tool.

The object of the invention was to create a device that enables easy handling of the blocking device for the knife.

The object was achieved by a device having the features of claim 15.

The device comprises a carrying device according to the first aspect of the invention and a tool. The first blocking means of the carrying device co-operate with an outer surface of the tool and form a control device with which the blocking device can be controlled. The control device can be used to control the blocking device such that it is moved, for example, into the blocking position or into the release position. For example, the first blocking means comprise a projection or a projecting pin. A region of the first blocking means comes into contact with the outer surface when the tool, e.g., a knife, is inserted. The formation of the outer surface, together with the formation of the pin, then controls the movement of the blocking device, in particular a button of the blocking device. For example, the button has a stable position for the blocking position and for the release position and a dead center in between, over which the button must be moved in order to reach the other position of the blocking position and the release position.

According to one embodiment, the first blocking means and the outer surface are formed such that-when the blocking device is in the blocking position-the blocking device remains in the blocking position when the tool is inserted into the receiving space, in particular into a receiving seat of the receiving space, and the tool is locked. For example, the button only moves out of the blocking position far enough for the tool to pass through the first blocking means, which can then move into engagement with the second blocking means of the tool, so that the tool is locked in the receiving space. A dead center formed between the blocking position and the release position is not overcome, for example.

As an alternative to the embodiment described in the previous paragraph or in addition thereto, the first blocking means and the outer surface are formed in such a way that—when the blocking device is in the release position—the blocking device is moved into the blocking position and the tool is locked when the tool is inserted into the receiving space. For example, another region of the outer surface interacts with the first blocking means. In this case, for example, the button is moved past a dead center from the release position into a blocking position.

According to an alternative embodiment to the embodiments described above, the first blocking means and the outer surface are designed such that the blocking device is moved from the blocking position to the release position when the tool is inserted into the receiving space. According to this design, the blocking device is automatically moved from the blocking position to the release position when the knife is inserted into the receiving space, so that the tool can then be locked by pressing the button. If the blocking device is in the release position, the insertion of the tool has no effect on the position of the blocking device.

Exemplary embodiments of the invention are described by way of example in the following description of the figures, also with reference to the drawings. For the sake of clarity, identical or comparable parts or elements or regions are designated with the same reference signs, sometimes with the addition of small letters, even where different exemplary embodiments are concerned.

Features that are only described in relation to one exemplary embodiment can also be provided within the scope of the invention in any other exemplary embodiment of the invention. Such modified exemplary embodiments—even if they are not shown in the drawings—are included in the invention.

All disclosed features are essential to the invention in themselves. The disclosure of the application hereby also includes in full the disclosure content of the associated priority documents (copy of the prior application) as well as the cited publications and the described prior art devices, also for the purpose of including one or more features of these documents in one or more claims of the present application.

In the drawings

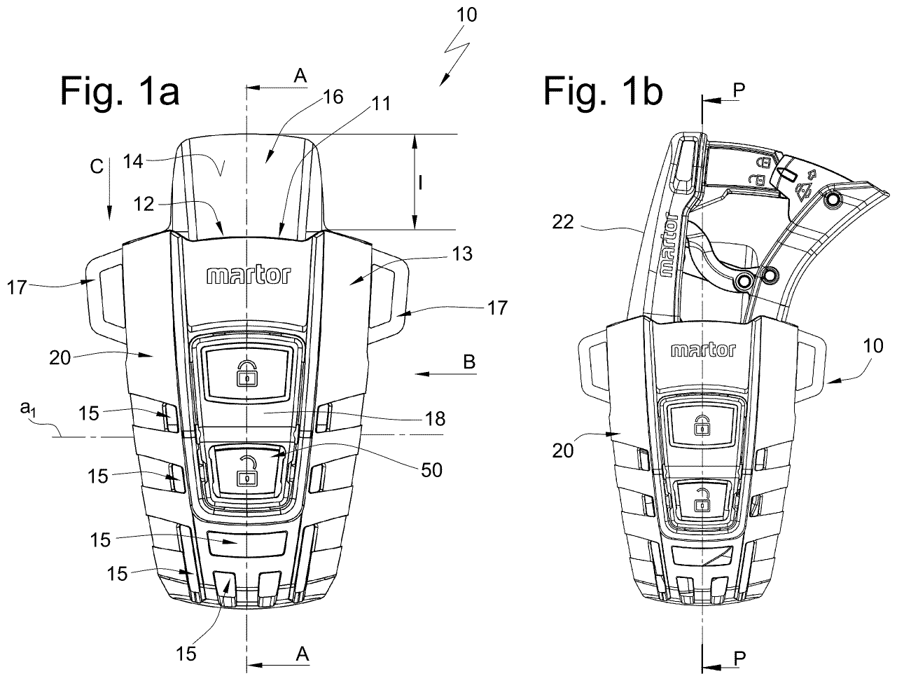

FIG. 1a shows a front view of the carrying device,

FIG. 1b shows the front view as shown in FIG. 1a, wherein a knife is held in the carrying device,

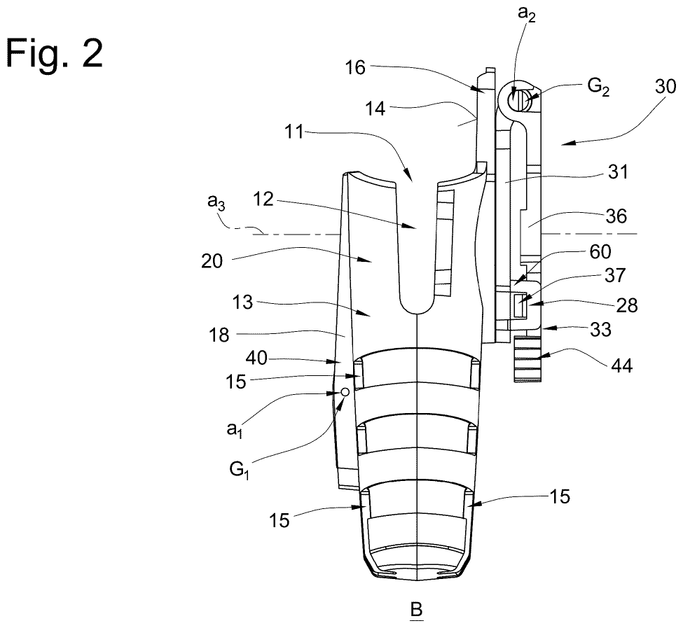

FIG. 2 shows a view according to view arrow B in FIG. 1a,

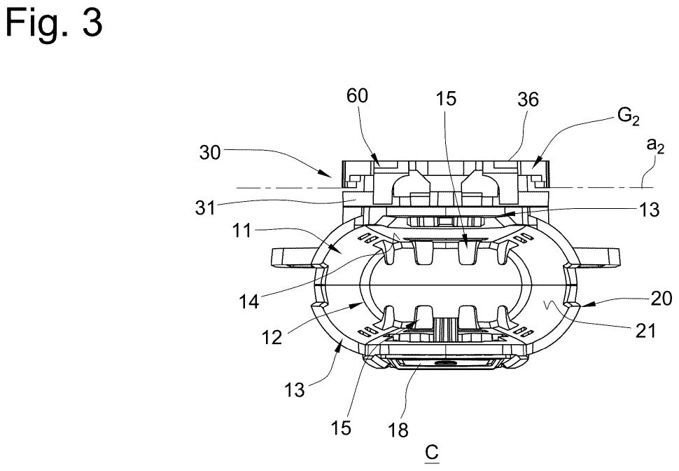

FIG. 3 shows a view according to view arrow C in FIG. 1a,

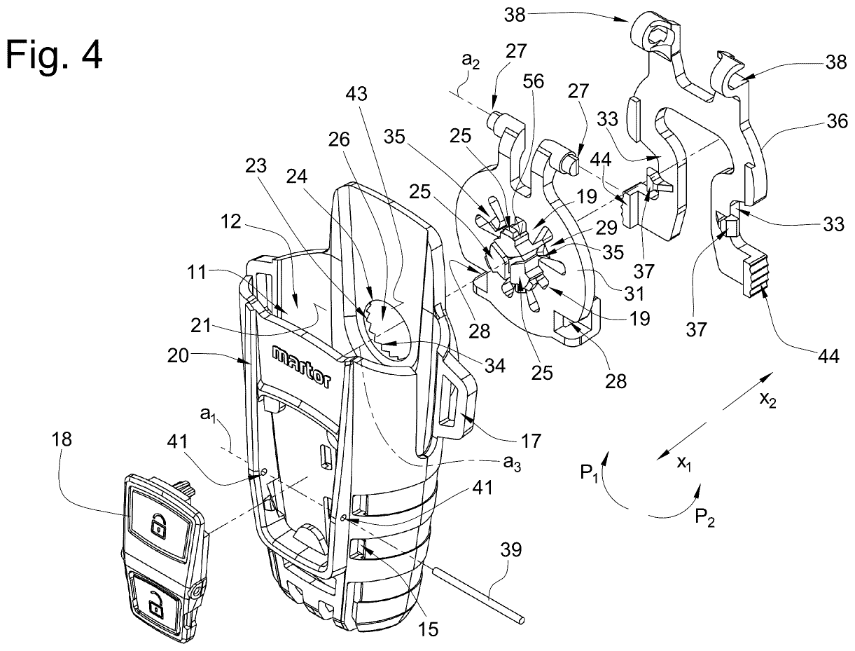

FIG. 4 shows an exploded view of the carrying device,

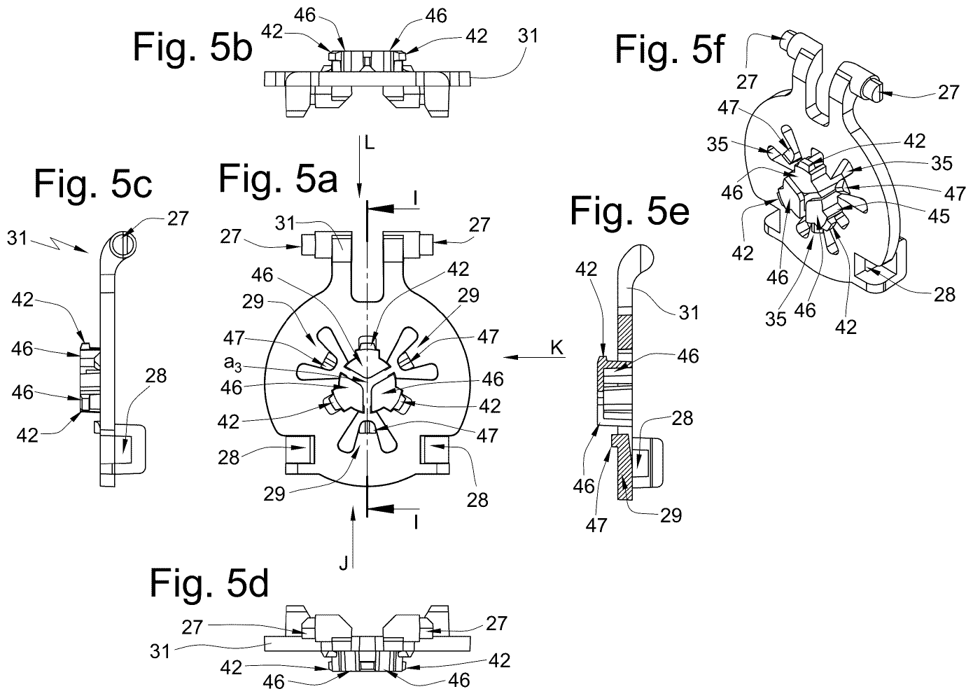

FIG. 5a shows a front view of a base part of the holding device in a single-part view,

FIG. 5b shows a view according to view arrow J in FIG. 5a,

FIG. 5c shows a view according to view arrow K in FIG. 5a,

FIG. 5d shows a view according to view arrow L in FIG. 5a,

FIG. 5e shows a sectional view according to line of section I-I in FIG. 5a,

FIG. 5f shows a perspective view of the base part,

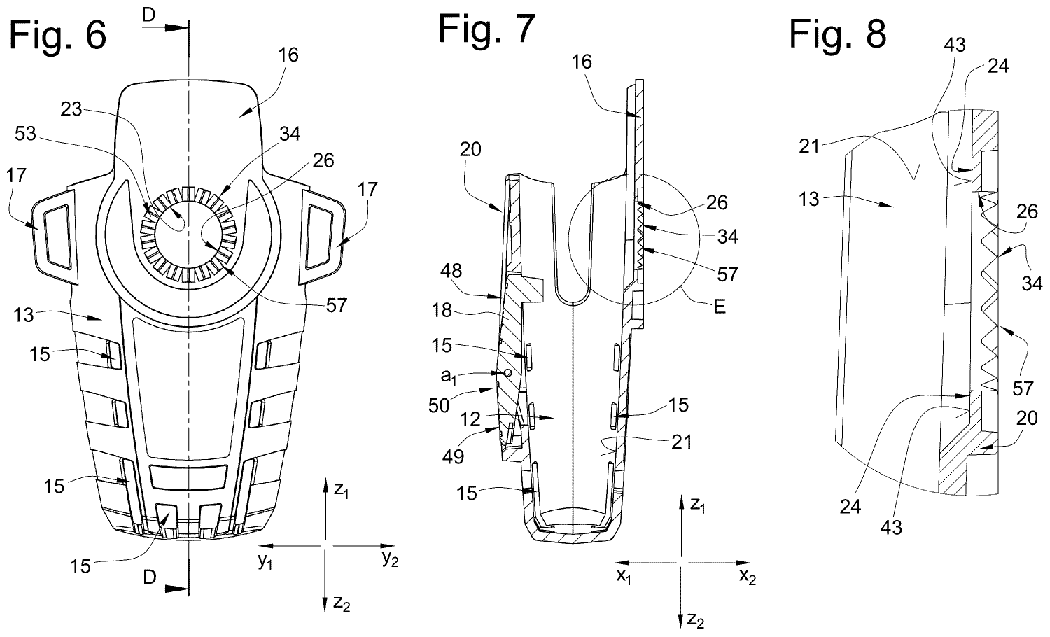

FIG. 6 shows a rear view of the receiving device of the carrying device without the holding device,

FIG. 7 shows a sectional view according to line of section D-D in FIG. 6,

FIG. 8 shows an enlarged view of section E in FIG. 7,

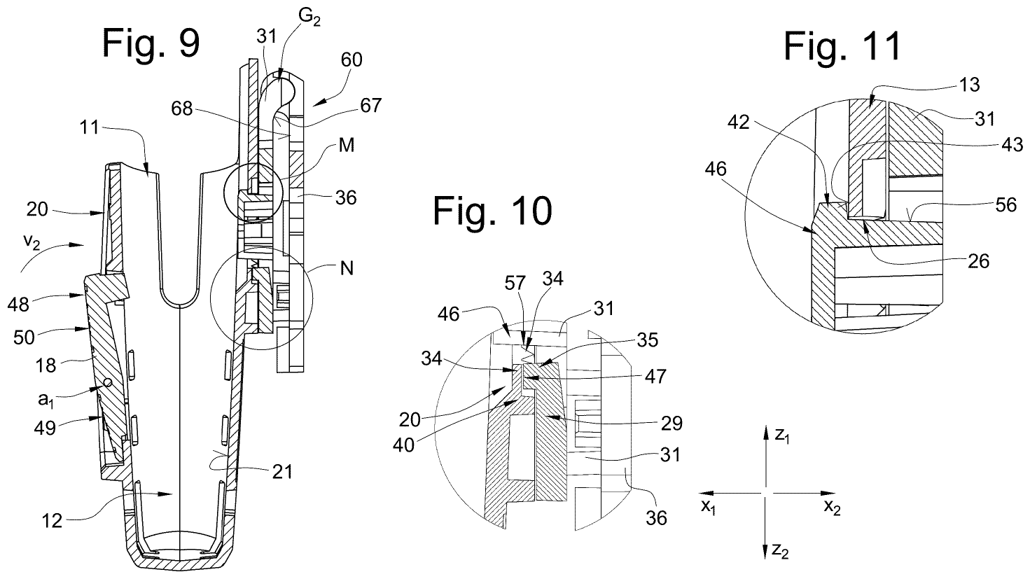

FIG. 9 shows a sectional view according to line of section A-A in FIG. 1,

FIG. 10 shows an enlarged view of the detail N in FIG. 9,

FIG. 11 shows an enlarged view of the detail M in FIG. 9,

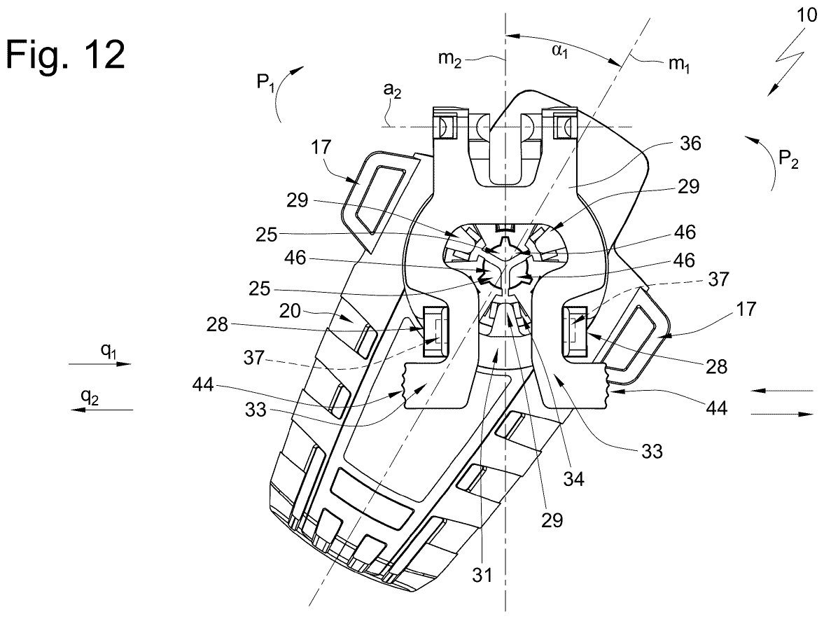

FIG. 12 shows a rear view of the carrying device, wherein the receiving device has a first angular position relative to the holding device,

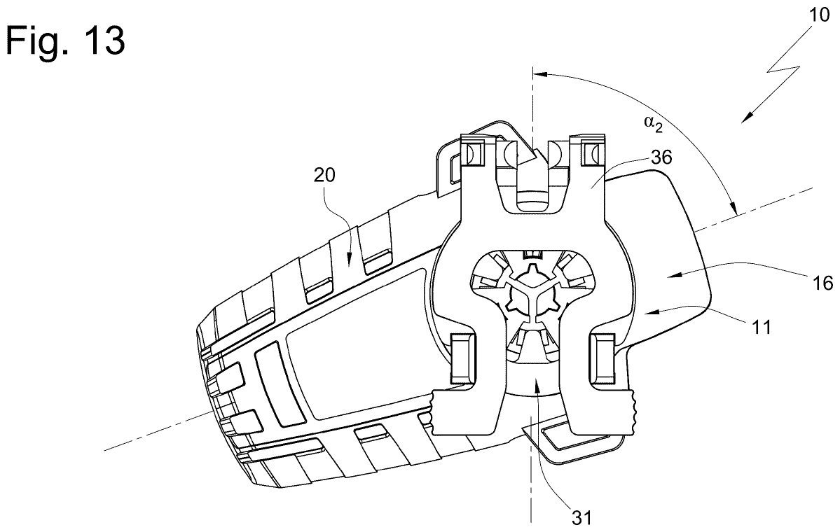

FIG. 13 shows a rear view of the carrying device, wherein the receiving device has a second angular position relative to the holding device,

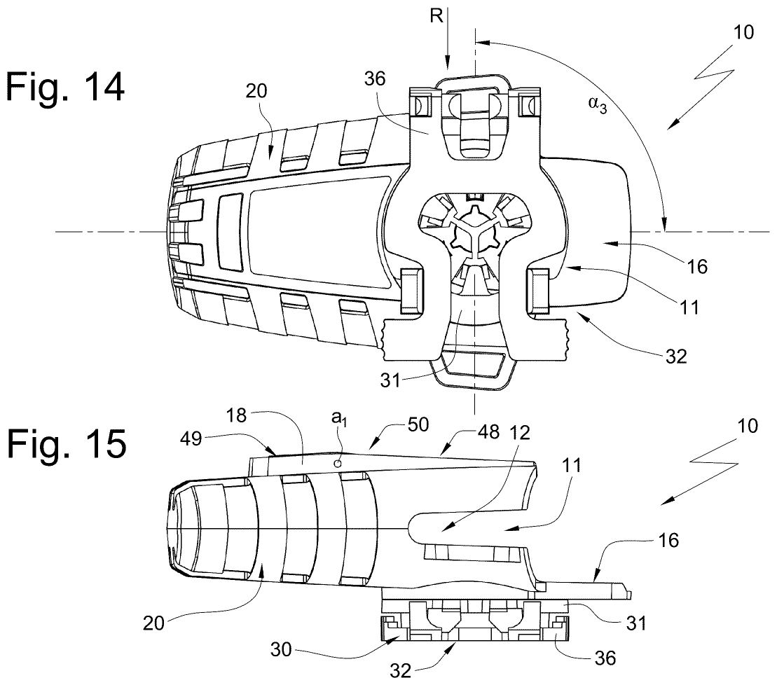

FIG. 14 shows a rear view of the carrying device, wherein the receiving device has a third angular position relative to the holding device,

FIG. 15 shows a view according to view arrow R in FIG. 14,

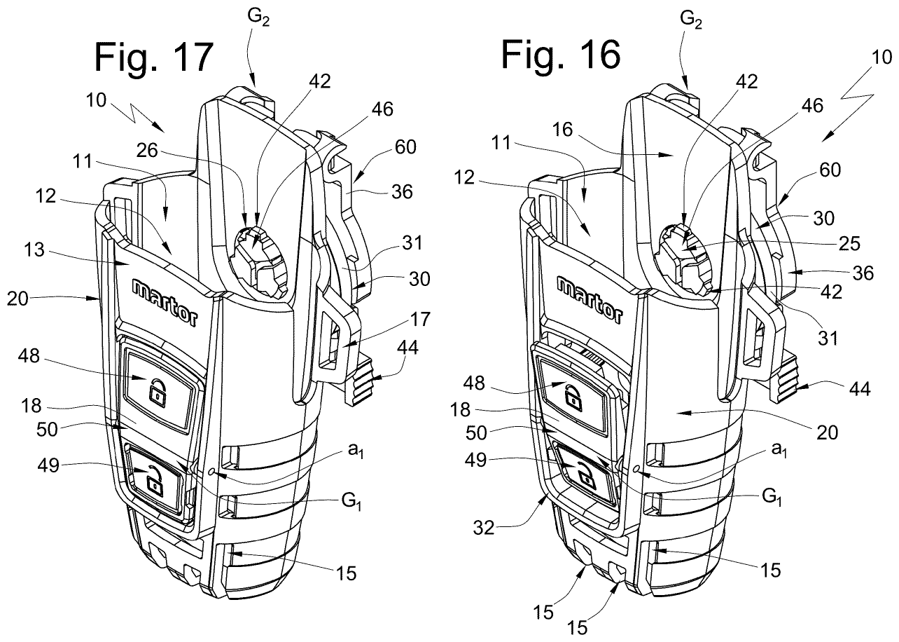

FIG. 16 shows a perspective view of the carrying device, wherein a button of a blocking device is arranged in a blocking position,

FIG. 17 shows is a perspective view of the carrying device based on FIG. 16, wherein the button is arranged in a release position,

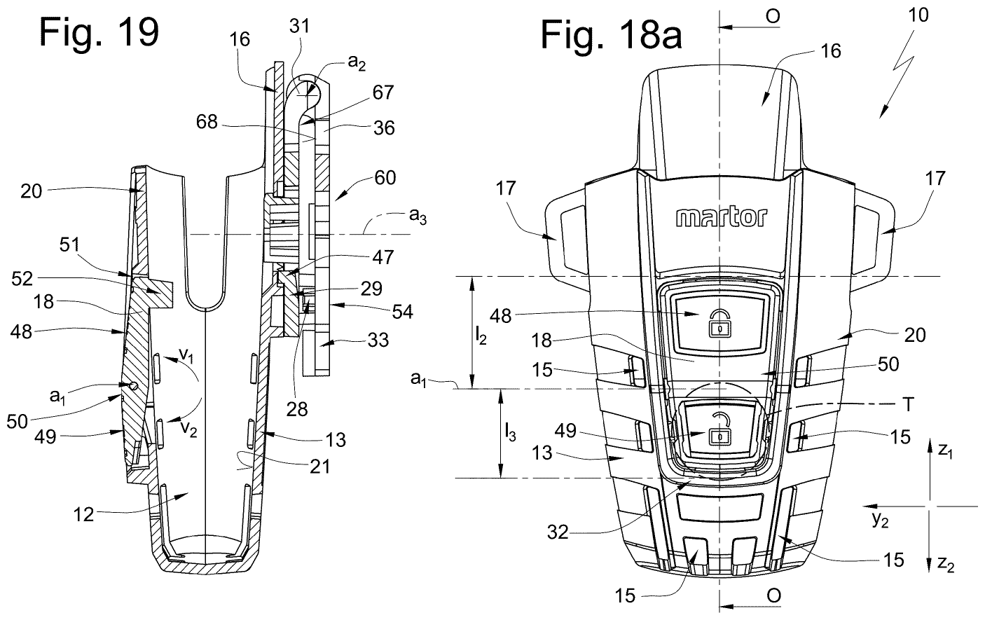

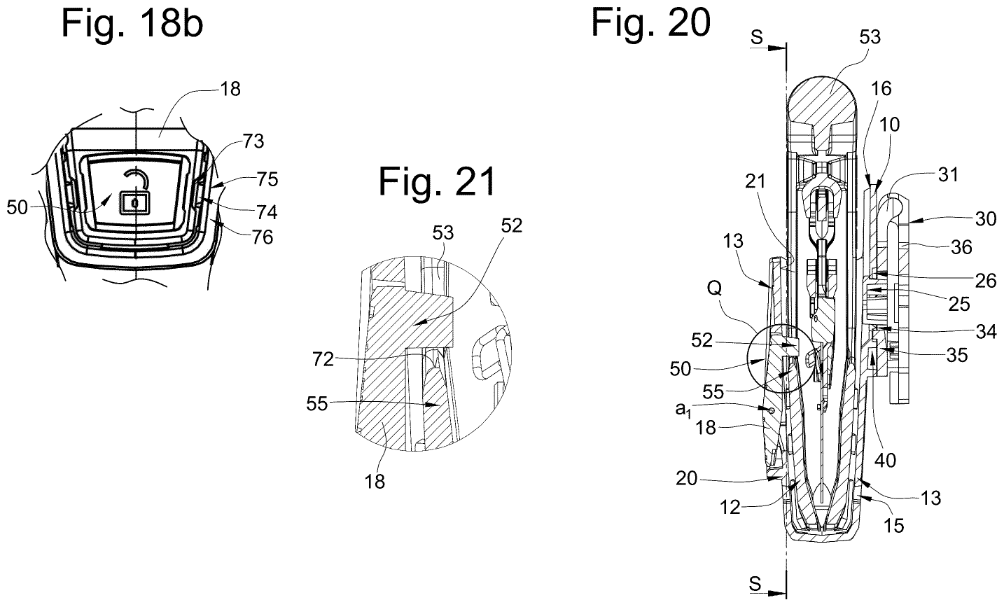

FIG. 18a shows a front view of the carrying device in the blocking position,

FIG. 18b shows a detail according to detail line T in FIG. 18a,

FIG. 19 shows a sectional view according to line of section O-O in FIG. 18a,

FIG. 20 shows a sectional view according to line of section P-P in FIG. 1b,

FIG. 21 shows an enlarged view of the detail Q in FIG. 20,

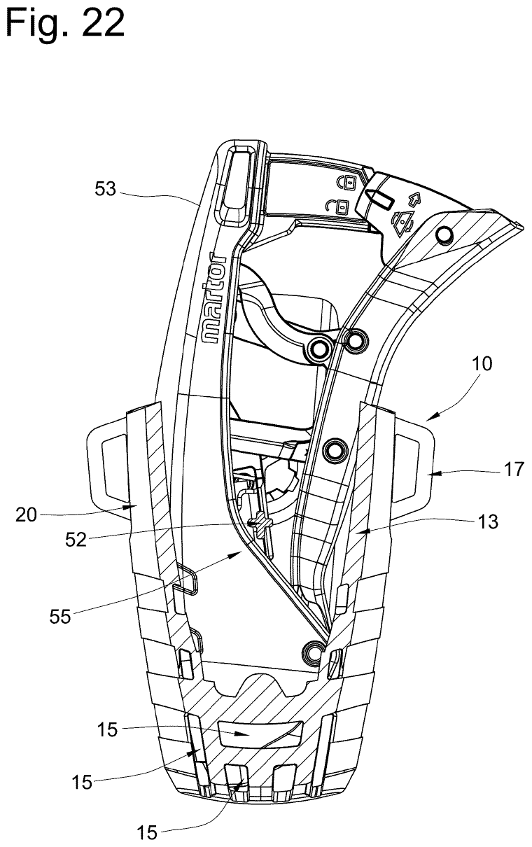

FIG. 22 shows a sectional view according to line of section S-S in FIG. 20,

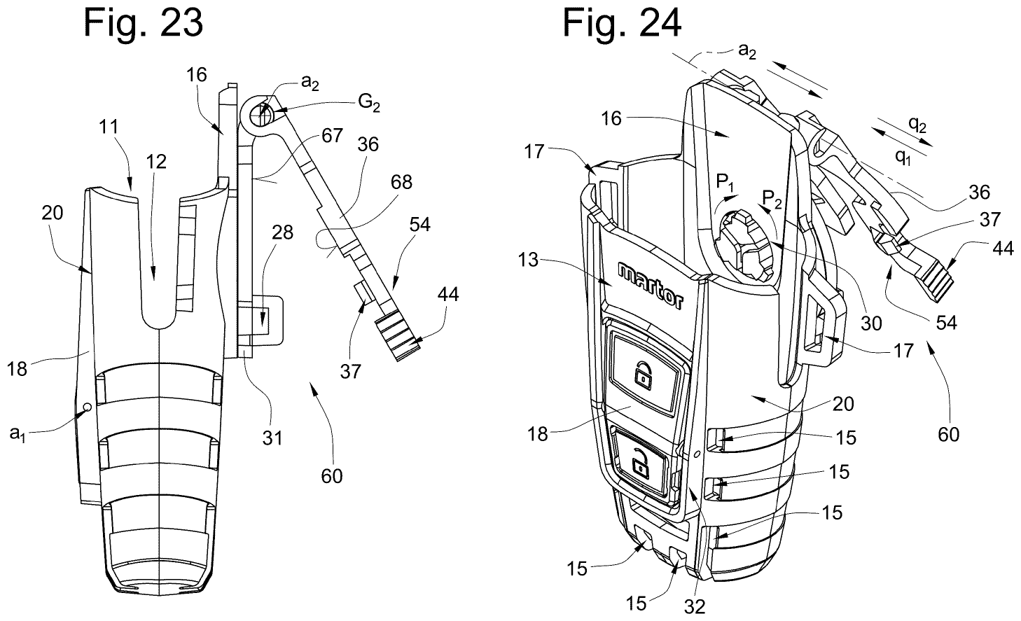

FIG. 23 shows a side view based on FIG. 2, wherein a hinge part of the fastening device is arranged in an open position,

FIG. 24 shows a perspective view of the carrying device according to FIG. 23,

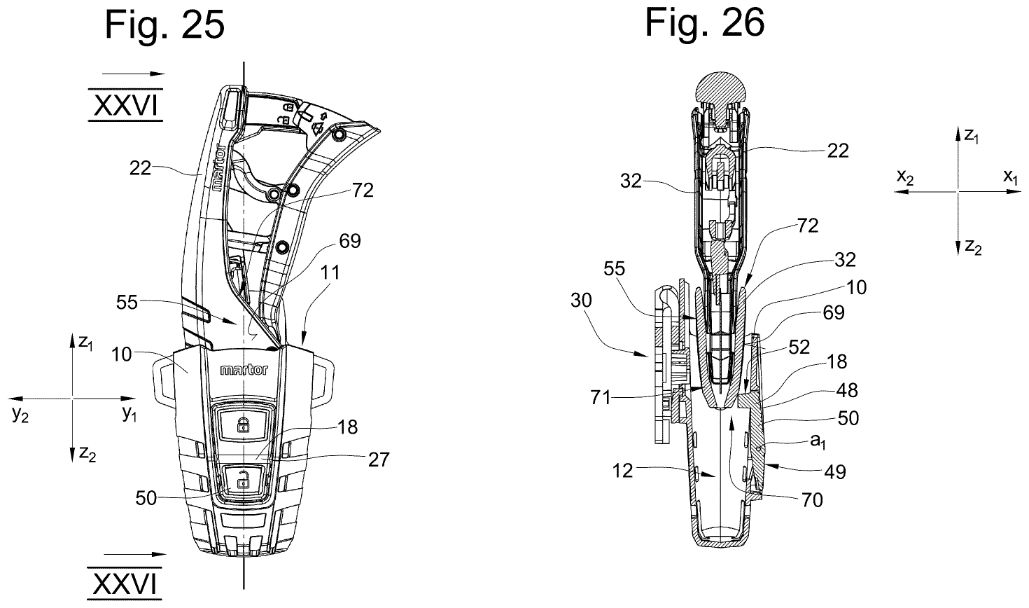

FIG. 25 shows a front view of a special embodiment of the carrying device with a tool in the form of a knife, wherein a front part of the tool in the form of a knife is inserted into a receiving space of the receiving device,

FIG. 26 shows a sectional view according to line of section XXVI-XXVI in FIG. 25,

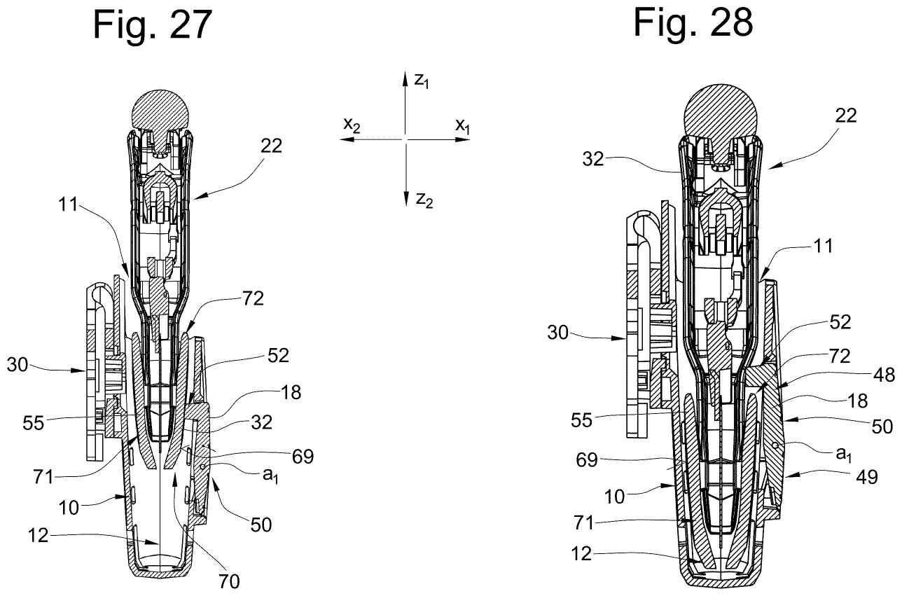

FIG. 27 shows a sectional view based on FIG. 26, wherein the tool 22 is moved further in the direction z2 into the receiving space,

FIG. 28 shows a sectional view based on FIG. 27, wherein the tool 22 is located completely in the holding seat in the receiving space.

A carrying device as a whole is labelled with the reference sign 10 in the figures. FIG. 1a shows a front view of the carrying device 10. The carrying device 10 is used to hold a tool 22, here in the form of a knife, as shown in FIG. 1b. The carrying device 10 comprises a receiving device 20, a holding device 30 and a locking device 40.

The receiving device 20 is housing-like and has a receiving space 12, which is bounded by a wall 13. The tool 22 can be inserted into and removed from the receiving space 12 via an upper opening 11. A wall region 16 forms a guide surface 14, which guides the tool 22 into the receiving space. An upper end of the wall 16 projects beyond an upper edge of the opening 11 with a length I.

Openings 15 in the wall 13 give the carrying device 10 a light visual appearance and allow dirt particles that have entered the receiving space 12 to escape. Fastening means in the form of eyelets 17 allow the fastening of a cable or strap (not shown), which on the other hand is connected to the knife 22, or the fastening of other objects to the carrying device 10. The wall 13 is formed in such a way that contact with a cutting edge of the tool 22 and thus injury is not possible when the tool 22 is in the receiving space 12. The receiving device 20 is made substantially of plastic, for example. Metal and composite plastics, for example, can also be used for the receiving device 20.

To secure the knife 22 in the receiving chamber 12 against falling out unintentionally, the carrying device 10 in the present exemplary embodiment has a blocking device 50. This comprises a button 18 with which the blocking device 50 can be switched between a blocking position and a release position. In the blocking position, the tool 22 is secured in the receiving space 12 and in the release position, the tool 22 can be removed from the receiving space 12. In the present exemplary embodiment, the button 18 is designed as a rocker button that can be adjusted between the blocking position and the release position. Alternatively, however, other actuations are also possible. The blocking device 50 is explained in greater detail below.

FIG. 2 shows a side view of the carrying device 10. A base part 31 is recognisable, which is part of a holding device 30 and part of a fastening device 60, e.g. for fastening the receiving device 20 to an item of clothing of the user or to a piece of furniture. The receiving device 20 is detachably attached to the base part 31 by means of the holding device 30, which is not fully recognisable in FIG. 2, and is mounted on the base part 31 so as to be pivotable about a pivot axis a3. In this example, the bearing is designed as a plain bearing. Alternatively, other bearings could be used. In this case, however, a plain bearing offers the possibility of simple detachability of the receiving device 20 from the base part 31 and only incurs low costs.

In this exemplary embodiment, the holding device 30 can be pivoted through 360° relative to the base part 31. Alternatively, however, the pivot radius could be limited.

FIG. 3 shows a top view of the carrying device in which the receiving space 12 is recognisable through the opening 11. The openings 15 at the bottom of the receiving device 20, through which dirt particles can escape from the receiving space 12, are recognisable.

FIG. 4 shows an exploded view of the carrying device 10. FIG. 4 shows the button 18, the receiving device 20, the base part 31 and a closing part 36. The base part 31 has second holding means 25, which co-operate with first holding means 24 of the holding device in order to ensure detachable fastening and rotatable mounting. The first holding means 24 are formed by an edge surface 43 of a recess 26 in the wall 13 of the receiving device 20. The edge surface 43 is part of an inner surface 21 of the receiving device 20. In other words, the edge surface 43 surrounds the recess 26 and, together with hook projections 42 of the base part 31, prevents the base part 31 from detaching from the receiving device 20.

In this exemplary embodiment, the second holding means 25 are formed in the form of three separate blocks 46, which project from the plate-shaped base part 31 in the direction x1 towards the receiving device 20, wherein each block 46 is mounted on an end region of at least one spring bar 19, which is elastically deformable. In this way, each block 46 can be moved radially inwards against the elastic spring force of the spring web 19. Spaces between the blocks 46 allow the movement radially inwards. A bearing surface 56 of all three blocks 46 together produces the shape of a circular cylinder, which is intended to engage through the recess 26 and form a common bearing surface for the pivot bearing. The number of blocks was chosen here as an example. Alternatively, there could also be 2 or 4 blocks 46, for example, the bearing surfaces 56 of which form a common bearing surface for the pivot bearing of the receiving device 20.

Each block 46 is provided with the hook projection 42 (see FIG. 5a), which projects radially outwards from a free end region of each block 46. When each block 46 moves inwards elastically, the blocks 46 can be guided through the recess 26 in the direction x1 when the receiving device 20 is mounted on the base part 31. When the load is released, the blocks move radially outwardly, wherein each hook projection 42 overlaps the edge surface 43 of the recess 26 on a side of the wall 13 opposite the base portion 31. If this is the case, the base part 31 cannot be moved in direction x2 and released from the receiving device 20. The rotatability of the receiving device 20 relative to the base part 31 in the directions p1 and p2 is ensured due to the interaction of the bearing surface 56 with the reveal 23.

Angled surfaces on the hook projections 42 support the radial inward movement in direction x1 relative to the receiving device 20 during assembly of the base part 31 when these come into contact with the reveal 23 of the recess 26. To remove the base part 31, the blocks 46 can be moved radially inwards by pressing on their common center (pivot axis a3) and then the holding means 25 can be released from the receiving device 20 in direction x2. This detachability of the receiving device 20 from the base part 31 enables and simplifies cleaning of the carrying device 10.

On the bearing surface 56, each of the three blocks 46 has web projections 45 extending in the direction parallel to the pivot axis a3. When the first holding means 24 are in engagement with the second holding means 25, these are in contact with the reveal 23 of the recess 26 and together with this form a plain bearing for rotatably mounting the receiving device 20 relative to the base part 31 in the directions p1 and p2 about the pivot axis a3.

The locking device 40 of the carrying device 10 is designed to secure the set rotational position of the receiving device 20 relative to the base part 31. The locking device 40 has first blocking means 34 (see FIGS. 6 to 11), which are assigned to the receiving device 20, and second blocking means 35, which are assigned to the base part 31. In this exemplary embodiment, the second blocking means 35 (see also FIGS. 5a to 5f) have a tooth projection 47 extending in the direction x1, which is directed towards the first blocking means 34.

The tooth projection 47 is formed on a free end region of a spring web 29, which is exposed in the plane of the plate-shaped base part 31. In the present example, the second blocking means have three tooth projections 47, which are arranged offset by 120° about the axis of rotation a3. Alternatively, a different number of tooth projections 47 can be selected. In the present construction, the second blocking means 35 are arranged radially outside the axis of rotation a3 with respect to the second holding means 25, which is advantageous in terms of a space-saving design.

FIG. 6 shows a rear view of the receiving device 20. It can be seen that the first blocking means 34 are formed by a toothing 57, which surrounds the recess 26 or, in other words, is formed on an edge region 53 of the recess 26 facing the base part 31. In the present example, the toothing is formed over an angle of 360° in relation to the axis of rotation a3. This enables locking in all rotational positions of the receiving device 20 relative to the base part 31 over an angle of 360°. If less adjustment of the receiving device 20 is desired, the first blocking means 34 can also be formed only at a smaller angle, e.g., 90° from the vertical in both directions of rotation p1 and p2.

FIGS. 7 and 8 show that the toothing 57 takes up little installation space and the extent in the direction x1 and x2 is small.

FIGS. 10 and 11 show details of the holding device 30 and the locking device 40. FIG. 10 shows the engagement of the tooth projection 47 in a recess in the toothing 57. The toothings 47 and 57 are designed here as a latching device, so that when a minimum torque on the receiving device 20 is exceeded in one of the directions of rotation p1 or p2, the tooth projection 47 automatically moves in the direction x2 out of engagement with the toothing 57 and moves into engagement with the toothing 57 in the set rotational position due to the restoring force of the spring bar 29. FIG. 11 shows how the hook projection 42 detachably engages over the edge surface 43 in the blocking position.

FIGS. 12 to 15 show examples of different pivot positions of the receiving device 20 relative to the base part 31. In FIG. 12, an angle α1 of approximately 30° is formed between a longitudinal center axis m1 of the receiving device 20 and a longitudinal center axis m2 of the base part 31. In FIG. 13, the angle α2 between the longitudinal central axes m1 and m2 is approximately 70° and in FIG. 14, the angle α3 between the longitudinal central axes m1 and m2 is approximately 90°.

The blocking device 50 is explained below, with which the removal of the knife 22, which is held in the receiving chamber 12, can be prevented. The blocking device 50 comprises the button 18, which is pivotably mounted about a pivot axis a1 in the pivoting directions v1 and v2. The geometric pivot axis a1 is formed by a physical journal 39 (only recognisable in FIG. 4), which is mounted in journal recesses 41 of the receiving device 20 and forms a joint G1 with the latter (see FIGS. 16 and 17).

The button 18 is designed as a two-armed lever and has two regions 48 and 49 according to FIG. 16, wherein the region 48 is located above the pivot axis a1 and the region 49 is located below the pivot axis a1. The actuation 18 can be moved in a rocker-like manner between a blocking position and a release position by pressing on the respective region 48 or 49. FIG. 16 shows the release position and FIG. 17 the blocking position. FIG. 18a shows a front view of the carrying device, wherein the blocking device 50 is in the blocking position. In FIG. 18a it can be seen that the region 48 has a greater longitudinal extent 12 from the pivot axis a1 in the direction z than the region 49, which has a longitudinal extent 13. In addition, region 48 has a larger surface region than region 49. The blocking position is therefore easier to set than the release position.

The button 18 is framed by a raised rim 76, which makes it stand out haptically and can be easily felt without having to see it.

The button 18 is provided (see FIG. 18b) with first positioning means 73 and the housing 32 with second positioning means 74 of a positioning device 75. The first positioning means 73 and/or the second positioning means 74 are designed to be elastic, for example. The button 18 is held stably in the blocking position or in the release position by the co-operating first and second positioning means 73 and 74, i.e., the button 18 does not inadvertently move to a position other than the respective set position. In the blocking position and/or in the release position, the button 18 can, for example, have a certain range of movement.

For example, the first positioning means 73 and second positioning means 74 are formed by elastically deformable lips, wherein the first positioning means 73 are located in the path of movement of the second positioning means 74 when the button 18 is moved between the blocking position and the release position and can be overcome by elastic deformation of the positioning means 73 and 74.

To move from the release position to the blocking position or vice versa, it is necessary to overcome a dead center of the first and second positioning means. The dead center is a relative position of the first and second positioning means in which the button is located neither in the blocking position nor in the release position, but exactly in between.

In the sectional view according to FIG. 19, it can be seen that a blocking pin 52 of the actuation 18 in the blocking position engages through an opening 51 in the wall 13 of the receiving device 20 and engages in the receiving space 12. The button can be pivoted about the axis a1 in the directions v1 and v2. In the release position, which can be seen in the sectional view according to FIG. 9, the button 18 has been pivoted in the direction v2 in relation to the position according to FIG. 19 and the blocking pin 52 barely protrudes into the receiving space 12. From the position according to FIG. 9, the blocking position is reached by pivoting in the direction v1.

FIGS. 19 to 22 show that the blocking pin 52 is located in the path of movement of a knife 22 received in the receiving chamber 12—in this case a housing wall 55 of the knife 22—when the knife 22 is moved in the direction z2. Removal or unintentional falling out of the knife 22 is therefore impossible.

Alternatively, the blocking pin 52 could also be located in the removal direction z1 in the movement path of other parts of the respective tool 22, thus blocking the removal from the receiving chamber 12.

In FIG. 23, a side view of the carrying device 10 is shown with reference to FIG. 2, wherein a fastening device 60 is provided for fastening the carrying device 10 to a belt or a bar. This comprises a closing part 36, which forms a pivot joint G2 with the base part 31. The base part 31 forms primary joint means 27 for this purpose, which co-operate with secondary joint means 38 of the closing part 36.

A free end region 54 of the closing part 36 can be pivoted away from the base part 31 about the pivot axis a2 by means of the pivot joint G2 relative to the base part 31 (see FIGS. 23 and 24). According to FIG. 23, the closing part 36 has been pivoted away from the base part 31 so that a carrying part, for example a belt, can be arranged between a first contact surface 67 of the base part 31 and a second contact surface 68 of the closing part 36. The first contact surface 67 faces the second contact surface 68.

At the end region 54, the closing part 36 has two elastically deformable arms 33, each of which is formed with a closing projection 37. The arms 33 are elastically movable towards each other in accordance with the arrows q1 in such a way that the closing projections 37 can be moved out of the blocking state of closing recesses 28 of the base part 31 by means of handles 44. By relieving the load on the handles 44, the closing projections 37 can move away from each other again in engagement with the closing recesses 28 due to elastic restoring force in accordance with the arrows q2.

In this way, the carrying device 10 can be secured, for example, to a belt or to a bar by arranging the latter between the base part 31 and the closing part 36, then bringing the closing part 36 into a parallel position to the base part 31 and then bringing the closing projections 37 into engagement with the closing recesses 28.

Alternatively, the joint G2 could also be designed as a living hinge, so that the base part 31 and the closing part 36 are connected to each other in one piece. Alternatively, the closing part 36 and the base part 31 could also be formed in one piece and connected by an elastic region that replaces the joint G2. In this case, the base part 31 and the closing part 36 would be connected in a clasp-like manner and the fastening device would not have a closing device comprising, for example, a closing projection and a closing recess.

FIGS. 25 to 28 show a particular embodiment of the blocking device 50. In this exemplary embodiment, a device comprising the carrying device 10 according to the invention and a knife 22 is described. In this example, the carrying device 10 and the knife 22 correspond substantially to the carrying device 10 and the tool 22 already described above. In this particular embodiment, the blocking pin 52 of the button 18 and a front region 71 of an outer surface 69 of the housing wall 55 form a control device 70 for controlling the blocking device 50.

In this example, the outer surface 69 and the blocking pin 52 are designed in such a way that—when the blocking device 50 of the carrying device 10 is in the blocking position and the knife 22 is inserted into the receiving space 12 of the carrying device 10 in the direction z2 according to FIG. 25—the blocking device 50 remains in the blocking position.

When the knife 22 is moved in the direction z2 into the receiving space 12 (see FIGS. 25 and 26), the blocking pin 52 comes into contact with the outer surface 69 of the housing wall 55. The outer surface 69 is shaped in such a way that it pivots the button 18 in the direction u1 when the knife 22 is moved relative to the carrying device 10. The button 18 is only pivoted in the direction u1 (see FIG. 27) to the extent that the knife 22 can pass the blocking pin 52 and move into the holding seat of the carrying device 10 (see FIG. 28). The button 18 then moves in the direction u2 back to the blocking position. In other words, the dead center of the positioning device 75 is not exceeded.

According to FIG. 28, the knife 22 is in the holding seat and the blocking device 50 is arranged in the blocking position. According to FIG. 30, the blocking pin 52 engages behind an edge 72 of the housing wall 55, so that movement of the knife 22 in the direction z2, i.e., in the removal direction from the receiving space, is prevented.

According to an alternative embodiment, the blocking pin 52 and the outer surface 69 could also be designed such that the blocking device 50 moves to the release position, wherein the dead center is exceeded when the knife 22 is inserted into the holding seat.

According to a further alternative embodiment or in addition to the features described above, the control device 70 could have a projection (not shown) on the button 18, which projection is arranged in relation to the pivot axis a1 at an end region of the button 18 opposite the blocking pin 52. If the blocking device 50 is in the release position and the knife 22 is inserted into the receiving space 12 of the carrying device 10, the outer surface 69 comes into contact with the projection and moves the button 18 past the dead center, so that the button 18 moves into the blocking position as shown in FIG. 30 when the knife 22 is in the holding seat as shown in FIG. 30.

1-18. (canceled)

19. A carrying device for a tool, comprising: a receiving device with a receiving space for receiving the tool; and a holding device for mounting and fastening the receiving device to a base part, wherein the receiving device has a blocking device with first blocking means, the locking device being movable by an actuation between a blocking position and a release position, by which the tool is releasably lockable in the carrying device.

20. The carrying device according to claim 19, further comprising an actuator that includes a button having at least one actuation region for moving the blocking device between the blocking position and the release position.

21. The carrying device according to claim 20, wherein the button has two actuating regions, wherein one of the actuating regions is assigned the blocking position and another of the actuating regions is assigned the release position.

22. The carrying device according to claim 20, wherein the button is configured to be movable between the blocking position and the release position by translational displacement and/or by rotation.

23. The carrying device according to claim 20, wherein the button is movable between at least a first stable position and a second stable position, wherein the first stable position is assigned the blocking position and the second stable position is assigned the release position.

24. The carrying device according to claim 20, wherein the button is latchable in the blocking position and/or in the release position.

25. The carrying device according to claim 20, wherein the button is a two-armed lever having two actuating regions separated by a pivot axis.

26. The carrying device according to claim 25, wherein the first actuating region is larger relative to the second actuating region.

27. The carrying device according to claim 20, wherein the button is arranged on an outer side of the receiving device.

28. The carrying device according to claim 27, wherein the button is actuatable on an outer side of the receiving device facing away from the holding device.

29. The carrying device according to claim 20, wherein the button is physically or functionally connected to the first blocking means, the first blocking means being movable at least in regions into a movement path of the tool so as to prevent the tool from moving out of the receiving device.

30. The carrying device according to claim 29, wherein at least one region of the first blocking means is movable into the receiving space through an opening in a wall of the receiving device.

31. The carrying device according to claim 20, wherein the receiving device has haptic detection means provided so as to permit location of an arrangement of the button by feel.

32. The carrying device according to claim 19, wherein the tool is a knife or comprises a knife.

33. A device, comprising: a carrying device according to claim 19; and a tool, wherein the first blocking means cooperate with an outer surface of the tool when the tool is inserted into the receiving space so as to form a control device by which the blocking device is controlled.

34. The device according to claim 33, wherein the first blocking means and the outer surface are configured so that when the tool is inserted into the receiving space, the blocking device remains in the blocking position and the tool is locked when the blocking device is in the blocking position.

35. The device according to claim 33, wherein the first blocking means and the outer surface are configured so that when the tool is inserted into the receiving space, the blocking device moves into the blocking position and the tool is locked when the blocking device is in the release position.

36. The device according to claim 33, wherein the first blocking means and the outer surface are configured so that when the tool is inserted into the receiving space, the blocking device is moved from the blocking position into the release position.
